(19) United States
(12) Patent Application Publication
(10) Pub. No.: US 2013/0116883 A1
(43) Pub. Date: May 9, 2013

(54) ARRANGEMENT AND METHOD FOR THE AUTOMATIC DOCUMENTATION OF SITUATIONS DURING FIELD WORK

(71) Applicant: Deere & Company, Moline, IL (US)

(72) Inventor: Georg Kormann, Zweibruecken (DE)

(73) Assignee: Deere & Company, Moline, IL (US)

(21) Appl. No.: 13/631,914

(22) Filed: Sep. 29, 2012

(30) Foreign Application Priority Data
Nov. 9, 2011 (DE) 102011086021.5

(51) Int. Cl. G06F 11/30; A01D 75/00

(52) U.S. Cl. 701/32.3

(57) ABSTRACT

An arrangement and a method for the automatic documentation of situations during fieldwork in which an operating parameter sensor records an operating parameter of an agricultural machine during field work or a crop sensor records a characteristic of the crop that is gathered or processed by the agricultural machine during the field work. A computer unit generates a triggering signal with the appearance of a pre-specified condition of the received signals of the operating parameter sensor or crop sensor. The computer unit is connected with an image recording device for the generation of an image signal by the agricultural machine or its surroundings. As a reaction to a triggering signal, image signals are stored in a geo-referenced manner and sent to a distant site over a transmission path.

### RELATED APPLICATIONS

This document claims priority based on German Patent Application No. 102011086021.5, filed Nov. 9, 2011, which is hereby incorporated by reference into this document.

1. Field of the Invention

The invention concerns an arrangement for the automatic documentation of situations during field work.

2. Background Art

In many cases, machines currently used in agricultural field work are more likely to be operated by workers that are less trained because of the pressure of costs, among other reasons. The specialist (for example, the farmer or manager) is seldom on the field to supervise or check the environmental conditions and the carrying out of the field work. Under these circumstances, in many cases the specialist is not able to determine afterwards why undesired or unforeseen events occurred, such as a field crop that has had very low yields. There may be different reasons for such events, such as a lack of or insufficient quantities of planted seeds, little or excessive water supply, the browsing of wildlife, incorrect use of agricultural chemicals, or poor soils.

In the state of the art, arrangements which make it possible for the operator of a harvesting machine to set so-called markers are known. By pressing a button, a marking is stored as a georeference in a card, which can also be provided with spoken comments so as to document for example, accumulated weed occurrences, insect infestation, the lack of water drainage, etc., and so as to be able to combat them later in a purposeful manner (See, e.g., European Patent Application No. EP 1 659 366 A2). These arrangements require sufficient technical knowledge on the part of the operator to be able to first recognize the situation and then evaluate it correctly and are not suitable for use by workers that are less trained.

Furthermore, image data from a camera and corresponding position data for an entire field can recorded to identify and perhaps later eliminate weeds with the help of the pictures (See, e.g., German Patent Application No. DE 43 29 343 A1). In certain prior art, enormous quantities of data are generated, which can only be evaluated mechanically and from which as a rule, a very small quantity of data is actually required.

German Patent Application No. DE 102 04 076 A1 describes a self-propelled harvesting machine with means to monitor the processing of the crops and a transfer path over which crop processing errors are sent to a station at a distant location. In turn, the station informs a computer belonging to the owner of the harvesting machine regarding these errors and makes it possible for him to change the settings of the harvesting machine. In this way, unfavorable settings of the harvesting machine can be improved, but details about the field and the crops are not given in the above German patent application.

### SUMMARY

In one embodiment, an arrangement for the automatic documentation of situations during the field work, comprises at least one operating parameter sensor for the recording of an operating parameter of an agricultural machine during field work or at least one crop sensor for the recording of a characteristic of the crop that is gathered or processed by the agricultural machine during field work. A computer unit is connected with the operating parameter sensor or the crop sensor. The computer unit is programmed to generate a triggering signal with the occurrence of one or more predetermined conditions of the received signals of the operating parameter sensor or the crop sensor. The computer unit is connected with an image recording device for the generation of an image signal of the agricultural machine or its surroundings. The computer unit is programmed to store image signals, in a geo-referenced manner, as a reaction to a triggering signal or to send them to a site at a distance, over a transmission path.

### BRIEF DESCRIPTION OF THE DRAWINGS

An exemplary embodiment of the invention described in detail below is shown in the following drawings, where:

FIG. 1 illustrates a side view of a harvesting machine with an arrangement in accordance with the invention for the automatic documentation of situations during field work; and

FIG. 2 illustrates a schematic diagram for a procedure according to which the arrangement works.

### DETAILED DESCRIPTION OF ILLUSTRATIVE EMBODIMENT(S)

The invention concerns an arrangement for the automatic documentation of situations during field work. In one embodiment, the arrangement comprises at least one operating parameter sensor for the recording of an operating parameter of an agricultural machine during field work or at least one crop sensor for the recording of a characteristic of a crop that is gathered or processed by the agricultural machine during field work. A computer unit is provided with the operating parameter sensor, the crop sensor, or both. The computer unit is programmed to produce a triggering signal and a corresponding method with the occurrence of a predetermined condition of the received signals of the operating parameter sensor, the crop sensor, or both.

The arrangement and method supports making available data to the specialist (farmer, manager, etc.), in an efficient manner, with which he can analyze situations during field work and can perhaps eliminate the causes. Thus, the improved arrangement and method for the automatic documentation of situations during field work does not have the aforementioned disadvantage(s) of the above discussed state of the art or has them only to a decreased extent.

An arrangement of the automatic documentation of situations during field work comprises: (1) at least one operating parameter sensor for the recording of an operating parameter of an agricultural feature during field work, (2) at least one crop sensor for the recording of a characteristic of the crop, or both that is gathered and/or processed by the agricultural machine during field work. Furthermore, a computer unit is connected with the operating parameter sensor, the crop sensor, or both. The computer unit programmed to produce a triggering signal with the occurrence of a prespecified condition of the received signals of the operating parameter sensor, the crop sensor, or both. The computer unit is also connected with an image recording device for the recording of an image signal of the agricultural machine, its surroundings and records, or all of the foregoing items, in a georeferenced manner, these aforementioned image signals in reaction to a triggering signal and/or sends them to a distant site over a transmission path.

In this way, the computer unit automatically recognizes, during the field work, a situation that is of interest for later evaluation in that the signals of the operating parameter sensor and/or the crop sensor are compared with a prespecified condition. At the very moment when such a triggering signal is generated, an image signal from the image recording device is stored for the purpose of later evaluation of the situation and its cause and the measures which are to be taken. The image recording device optically monitors the agricultural machine and/or its surroundings. Alternatively or additionally, the image signal is transmitted, via the transmission path, to a distant site, which can be located, in particular, on the farmyard of the agricultural machine or of the owner of the field, so that the farmer, the manager, or the contractor can promptly analyze the situation and if necessary, make decisions as to how to proceed further. Accordingly, the invention under consideration simplifies the monitoring of situations during field work, without unnecessarily accumulating enormous quantities of data.

For example, this predetermined condition can occur if the signals of the operating parameter sensor, the crop sensor, or both deviate by more than one threshold value from a theoretical value, which can be prespecified, statically and permanently, or can be taken from a card in which comparable data of previous operations are stored. Another possible condition can be that a deviation of the received signals of the operating parameter sensor, crop sensor, or both from a maximum or minimum value, recorded previously during work on the pertinent field by more than one threshold value occurs. In this way, the extremes of the field can be recorded, wherein the previously recorded image signals for the previously documented situation, which is now no longer considered to be extreme, can be deleted or can continue to be stored. It would also be possible to release a triggering signal, if the received signals of the operating parameter sensor, the crop sensor, or both fall into a pre-specified class. In this way, representative image signals for the individual classes, which can correspond, for example, to low, medium and high yields or different soil classes or different topographical conditions of the field.

The image recording device can comprise a camera that is sensitive, in particular, in the visible, infrared, or ultraviolet wavelength ranges, or any combination of the foregoing wavelength ranges, for the recording of stationary and/or movable images. Alternately, the image recording device may comprise a scanning laser distance measuring device, a scanning radar sensor, or both. Thus, stationary or movable images are generated for one or more of the following: an area in front of, an area behind the machine, or an area of the crop flow in the machine is generated. The image recording device is appropriately aimed at the area of the machine which can provide the most sensible information for the analysis of the situation. During the working of the soil it is aligned with the soil working tools of the agricultural machine, whereas with a harvesting machine, it is aligned with the standing plants in front of the harvesting machine or the crop flow within the harvesting machine.

The computer unit can store additional signals, as a reaction to a triggering signal and/or send them to the distant site; they contain, for example, the received signals of the operating parameter sensor and/or crop sensor and/or weather conditions and/or information regarding the individual operator of the machine and/or the time of the triggering signal. These additional signals can facilitate the analysis of the situation.

For example, the crop sensor records one or more of the following: the throughput, ingredients content or the color of the crop. The operating parameter sensor records, for example, the driving performance and/or power of a driven element (for example, soil processing tool) of the machine, which is moved over the field.

The computer unit generates different triggering signals for different conditions of the received signals of the operating parameter sensor and/or the crop sensor and stores different image signals and perhaps additional signals, depending on the individual triggering signal and sends them to the distant site. Accordingly, different types of situations can be recorded and classified and different data for further processing are made available, depending on the type of situation. For example, with a small crop throughput, an image of the field before a harvesting machine, perhaps together with signals of a measuring device for the recording of the contents of the crop can be recorded or sent off, so as to analyze the agronomic conditions of the pertinent site of the field, whereas with high threshing or cleaning losses in a combine harvester, other data regarding the throughput and the threshing drum and cleaning settings are stored and/or sent off, so as to be able to analyze the adjustment of the combine harvester.

The computer device is connected with an input device, with which the conditions of the signals of the operating parameter sensor and/or the crop sensor that lead to the generation of a triggering signal can be inputted and/or changed and/or the image signals and perhaps additional signals that are stored and/or sent off during the generation of a triggering signal can be inputted and/or changed. The operator or another authorized person can thus define under what conditions a triggering signal is released, preferably after inputting a password or another recognition feature (for example, fingerprint, facial or eye scanning, identification chip). Furthermore, it is possible to define what image signals and perhaps additional signals are stored or sent off with a triggering signal. Here, as mentioned in the preceding paragraphs, a distinction can be made between different triggering signals for different situations. The conditions and the stored or sent-off signals can however be statically and permanently specified in another embodiment.

The computer device can note the image signals in a yield card. In the evaluation of a harvesting process, accordingly, corresponding markings are contained on the places of the yield card on which situations documented by images have appeared. By clicking the markings, the specialist can display the stored image signals and perhaps other data. The analysis of the displayed image signals and data can be done by the specialist alone or supported by software which, in an advanced version, automatically generates, with the aid of image signals and data, suggested actions to overcome the situation.

The possibility also exists for storing the image signals continuously in a temporary storage unit and only with the generation of a triggering signal, for sending the image signals extending over a predefined time period, before and after the triggering signal, to a permanent storage unit. This also makes it possible to evaluate the image signals which were obtained shortly before the release of the triggering signal, since in many cases, they give good conclusion possibilities regarding the cause of the situation.

The arrangement, in accordance with the invention, can be used, in particular, on self-propelled harvesting machines or those drawn by a vehicle or mounted thereon, such as, combine harvesters, baling presses, or field choppers, but also on any other self-propelled agricultural machines, or those drawn by a vehicle or mounted thereon, in particular, for the processing of soil or for fertilizing, sowing, or spreading of chemicals.

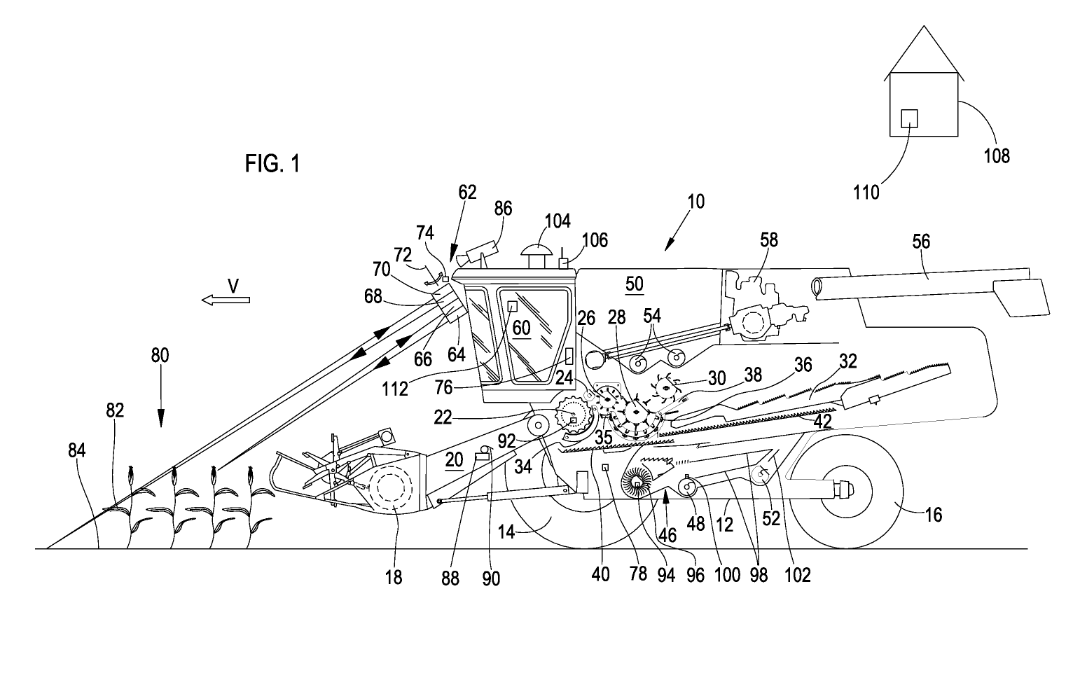

1 shows an agricultural machine 10 in the form of a self-propelled combine thresher with a frame 12, which is supported on the ground via driven front wheels 14 and steerable back wheels 16, and is moved forward by them. The wheels 14 are made to rotate by means of a driving means that is not shown, so as to move the agricultural machine 10, for example, to a field to be harvested. In FIG. 1, the direction indications, such as front and back, refer to the traveling direction V of the agricultural machine 10 during the harvesting operation.

A crop harvesting device 18, in the form of a cutting device, is connected in a detachable manner to the front end area of the agricultural machine 10, so as to harvest crops in the form of grains, or other threshable cereals from the field during the harvesting operation and to conduct them upwards and backwards, via an inclined conveyor 20, to a multidrum thresher, which comprises—in the traveling direction V, arranged one behind the other—a threshing drum 22, a stripping drum 24, a conveying drum 26, operating from above, a tangential separator 28 and a helical drum 30. Downstream from the helical drum 30, there is a straw-walker 32. The threshing drum 22 is surrounded by a threshing basket 34 in its lower and back areas. Below the conveying drum 26 there is a closed cover 35 or one provided with openings, whereas a stationary cover is located above the conveying drum 26 and below the tangential separator 28, a separating basket 36 with adjustable finger elements. A finger rake 38 is located below the helical drum 30.

The mixture containing the grains and impurities and passing through the threshing basket 34, the separating basket 36 and the straw walker 32 arrives, via conveying trays 40, 42, at a cleaning device 46 with a blower 96 and sieve 98. Grain cleaned by the cleaning device 46 is supplied, by means of a grain auger 48, to a nondepicted elevator, which conveys it to a grain tank 50. A returns auger 52 takes back unthreshed ear parts through an elevator not depicted further, to the threshing process. The chaff can be thrown out on the back side of the upper sieve 98 through a rotating chaff spreader, or it is discharged through a straw chopper (not depicted), located downstream from the straw-walker 32. The cleaned grain from the grain tank 50 can be discharged through a discharging system with transverse screws 54 and a discharging conveyor 56.

The aforementioned systems are driven by means of an internal combustion engine 58 and are controlled and steered by an operator from a driver's cabin 60. The different devices for threshing, conveying, cleaning and separating are located within the frame 12. Outside the frame 12, there is an external shell, which, for the most part, can be folded open. It should be noted that the multidrum thresher depicted here is only one example of an embodiment. It could also be replaced by a single, transversely arranged threshing drum and a subordinate separating device with a straw-walker or one or more separating rotors or a threshing and separating device, operating in the axial flow.

On the front side of the driver's cabin 60, a sensor arrangement 62 is located in the vicinity of the roof, which is connected with a computer device 76. The measuring device 62 could also be placed on the crop harvesting device 18. The computer device 76 is connected with a speed specification device 78 (for example, an adjusting device for a wobble plate of a hydraulic pump, which, so as to conduct the hydraulic fluid, is connected with a hydraulic motor, which drives the wheels 14), which is set up for the adjustment of the advance speed of the agricultural machine 10.

The measuring device 62 comprises a first transmitter 64, a first receiver 66, a second transmitter 68 and a second receiver 70, which together can rotate around a more or less vertical axle 74, which is slightly inclined forwards, by means of a rotary actuator 72. During operation, electromagnetic waves, sent out by the transmitters 64, 68, sweep a measuring area before the combine harvester 10, in that the senders 64, 68 and receivers 66, 70 (or merely elements transmitting and/or receiving their waves) are swiveled around the axle 72. In this way, the field 80 with the plants 82 on it is swept successively along a measurement direction, which extends in a circular-segment arc before the combine harvester 10.

The first transmitter 64 sends out first electromagnetic waves, in the form of light in the (near) infrared or visible wave range, whereas the first receiver 66 is sensitive only to this light. On the basis of the selected wavelength, the light is reflected from the plants 82, when it strikes them. If the light, on the other hand, strikes the ground 84 between plants (for example, when the groups of plants are thin or missing), it is reflected from the ground. The first transmitter 64 preferably comprises a laser for the production of the light.

The second transmitter 68 send off second electromagnetic waves in the microwave or radar wave range, whereas the second receiver 70 is sensitive only to these waves. The wavelength is selected in such a way that most of the second waves penetrate the plants and are reflected only by the ground 84. A certain, although smaller fraction of the second waves, is also reflected by the plants 82.

The electromagnetic waves sent off by the transmitters 64, 68 reach the ground 84 at a distance of some meters (for example, 10 m) in the traveling direction of the combine thresher 10 before the crop harvesting device 18. The waves transmitted by the senders 64, 68 can be amplitude-modulated or modulated in some other manner, so as to improve the signal/noise ratio. Via an elapsed time measurement, the computer device 76 implements a recording of the distance and/or another measurement variable between the measuring device 62 and the point at which the wave were reflected. The swivel drive 74 can be carried out as a servo or stepped motor and swivels the measuring device 62 (or only elements transmitting and/or receiving their waves), continuously or stepwise, around an angle range of, for example, 30°, back and forth around the axle 72. The computer device 76 is set up to record the individual angle around the axle 72 and the elapsed time of the wave or the distance of the receiver 66, 70 and the transmitter 64, 68 from the reflection time, for each swivel angle of the measurement device 62. Subsequently, the swivel drive 74 is activated and the measuring device 62 is brought to another setting. An evaluation device of the swivel drive 74 has information regarding the individual angle of the measuring device 62, since it controls the swivel drive 74. A separate sensor for the recording of the swivel angle would also be conceivable, wherein the servo or stepped motor can be replaced by any motor. The angle of the measuring device 62 around the axle 72 defines a measuring device 62 along which the elapsed times of the waves of the transmitter 64, 68 to the corresponding receiver 66, 70 are determined. It extends horizontally and in the form of an arc, transverse to the forward direction of the agricultural machine 10.

The signals of the first receiver 66 contain information regarding the height of the upper ends of the plants 82 as they are primarily reflected there. Some first waves, however, penetrate further downwards in thinner groups of plants—in part, right down to the ground 84—and are first reflected there and received by the first receiver 66. In thinner groups of plants, the distances recorded by the first receiver 66 accordingly vary more than in denser groups of plants. These different variations of the intervals, dependent on the group density, are evaluated on the evaluation device 74 and are used for the determination of the density of the plant group. Furthermore, the measurement values of the second receiver 70 are used to determine a soil profile, which is used for a more precise determination of the heights of the plants, which are also used to determine the number of plants—in conjunction with the highest of the upper sides of the plants 82, recorded with the first receiver 66.

From the roof of the driver's cabin 60, a camera 86 looks downwards and forwards at an incline onto the field 80 with the plants 82 standing there before the crop harvesting device 18. The signals of the camera 86 are also supplied to the computer device 76.

Furthermore, the agricultural machine 10 is equipped with several operating parameter sensors and crop sensors, which directly or indirectly record data regarding the operation of the agricultural machine 10 or the characteristics of the harvested plants 82 and send their signals to the computer device 76. A crop sensor 88 records the angle position of a scanner 90 that is supported so it can rotate, which interacts with the crop mat in the inclined conveyor 20. The crop sensor 88 accordingly records the layer thickness of the plants 82 in the inclined conveyor 20. An operating parameter sensor 92 records the torque or the driving performance of the threshing drum 22, which, in turn, depends on the quantity (volume and mass) of the gathered plants 82. An operating parameter sensor 94 records the driving torque or the driving performance of the blower 96, which depends on the covering of the sieve 98. A crop sensor 100 comprises a camera and a near-infrared spectrometer, which interact with the cleaned grain, conveyed by the grain auger 48 by means of the camera and an image processing. The cleaning of the grain and the broken grain fraction in the cleaned grain and the grain moisture and other contents such as the protein content is determined by means of the near-infrared spectrometer. In this regard, reference is made to the disclosure of German Patent Application No. DE 10 2007 007 040 A1, and its counterpart U.S. Pat. No. 7,804,588. Finally, a crop sensor 102 records the loss in grain at the outlet of the upper sieve 98.

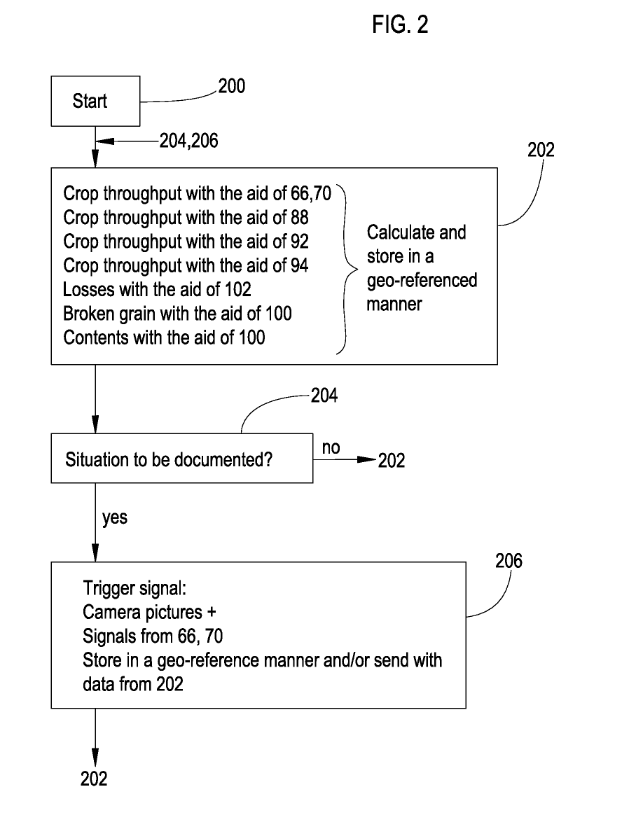

FIG. 2 illustrates the mode of operation of the arrangement, in accordance with the invention for the automatic documentation of situations during field work.

After the start in step 200, an evaluation is carried out, in step 202, by the computer device 76 to determine the crop throughput with the aid of the signals of the receiver (66, 70). Details in this regard can be found in German Patent Application No. DE 10 2008 043 716 A1, which discloses an evaluation device for determining population density of plants, and German Patent Application No. DE 10 2011 085 380 A1, whose disclosures are incorporated by reference to the documents. Furthermore, the crop throughput is determined with the aid of the signals of the crop sensor 88 and the operating parameter sensors 92 and 94. Moreover, the losses are determined with the aid of the crop sensor 102 and the broken grain fraction and the contents (moisture, protein content) of the grain with the aid of the crop sensor 100. These data are stored in a geo-referenced manner together with the position data of a satellite signal-based position determining system 104, so as to document the field work.

In the following step 204, an evaluation is carried out as to whether a situation to be documented photographically (e.g., via image signals) is present. To this end, the crop throughputs from step 202 can be compared with a yield card from the preceding year. If the deviation between the crop throughputs currently measured with the crop sensors (66, 70, 88) and the operating parameter sensors (92 and 94) and the expected crop throughputs is greater than a threshold value, then a first situation to be documented photographically is present.

Analogously, for step 204 a second situation to be documented photographically is present if losses recorded with the aid of the crop sensor 102 are greater than a predetermined threshold value, which can be for example, 2% or is taken from the yield card. A (third) situation to be documented photographically is present if the broken grain fraction is greater than a predetermined threshold value or the moisture content of the grain is greater than a predetermined threshold value or the protein content of the grain is smaller than a predetermined threshold value. Furthermore, a situation to be documented photographically could be present, if the crop throughput falls into a predetermined class (small, medium high) or exceeds the previous minimum or maximum value by a specific threshold of for example, 10%. If none of the aforementioned situations is present, then step 202 again follows.

Otherwise, step 206 follows, in which a triggering signal is released and image signals (extending, from time to time over an interval before the triggering signal to after the triggering signal) of the camera 86 are taken from a temporarily, continuously described and again deleted storage unit and stored together with the signals of receivers 66, 70, extending over the aforementioned time interval and the data from step 202. These data, including the image signals of the camera 86 and the signals of the receivers 66, 70 can be taken from the yield card produced in step 202, so as to be able to evaluate them later. Alternatively or additionally, the aforementioned data and signals are sent, in step 206, to an evaluation computer 110 at a distant site 108, via a transmitting device 106.

The triggering signal can be used internally in the computer device 76, or the operator in the driver's cabin 60 can be shown a display or given an acoustic indication so that he himself can also react to the situation within his capabilities. The specialist (manager, farmer, contractor, or the like) at the distant site can analyze photographically documented situations which possibly require a reaction—either after the arrival of the triggering signal and the aforementioned data and signals via the transmitting device 106 or after the end of the work on the field and a transfer of the data from FIG. 2, wirelessly or by means of a transportable storage medium on the evaluation computer 110. To this end, it may be sufficient for him to look at the images of the camera 86 on a display of the evaluation computer 110, or in an advanced embodiment, the evaluation computer 110 can offer suggested actions to him. They can be sent to the operator of the machine 10 via the transmitting device 106, designed also as a receiver (or via any other connection, for example, mobile telephone connection).

An input device 112 makes it possible for the operator or another authorized person, after the input of a password to define or to change the criteria for the release of the triggering signal. Furthermore, by means of the input device 112, he can define or change the data or signals that are stored or transmitted in steps 202 and 206 (for example, the duration of the stored and/or transmitted signals of the camera 86).

It should also be noted that the signals could also be sent continuously to the camera 86 by the computer device 76. In this way, for example, obstacles in front of the machine 10 could be recognized and used to generate a triggering signal (and to generate a stop signal for the operator or the speed specification device 78). Information regarding the color of the crop could also be extracted from the signals of the camera 86 and are treated as crop parameters in steps 202, 204 and 206 of FIG. 2, so that, for example, a triggering signal can be generated with excessively green or lying crops.

Having described one or more embodiments, it will become apparent that various modifications can be made without departing from the scope of the invention as defined in the accompanying claims. Further embodiments of the invention may include any combination of features from one or more dependent claims, and such features may be incorporated, collectively or separately, into any independent claim.

1. An arrangement for the automatic documentation of situations during the field work, the arrangement comprising the following:
at least one operating parameter sensor for the recording of an operating parameter of an agricultural machine during field work or at least one crop sensor for the recording of a characteristic of the crop that is gathered or processed by the agricultural machine during field work; and
a computer unit, connected with the operating parameter sensor or the crop sensor, which is programmed to generate a triggering signal with the occurrence of a predetermined conditions of the received signals of the operating parameter sensor or the crop sensor;
wherein the computer unit is connected with an image recording device for the generation of an image signal of the agricultural machine or its surroundings and is programmed to store image signals, in a geo-referenced manner, as a reaction to a triggering signal or to send them to a site at a distance, over a transmission path.

2. The arrangement according to claim 1, characterized in that the computer unit is programmed to create a triggering signal, if one or more of the following occur:
(a) a deviation of the received signals of the operating parameter sensor or the crop sensor from an expected theoretical value of more than one threshold value appears;
(b) a deviation of the received signals of the operating parameter sensor or crop sensor from a previously appeared maximum or minimal value of more than one threshold value appears;
(c) the received signals of the operating parameter sensor or crop sensor fall into a predetermined class.

3. The arrangement according to claim 1, wherein the image recording device has one or more of the following items: a camera to record stationary or movable images, a scanning laser distance measuring device, or a scanning radar sensor.

4. The arrangement according to claim 1, wherein the image recording device is sensitive to one or more of the following ranges: a visible wavelength range, an infrared wavelength range or an ultraviolent wavelength range.

5. The arrangement according to claim 1, wherein in that the image recording device is aimed at the crop flow in the machine, on an area before the machine, or on an area behind the machine.

6. The arrangement according to claim 1, wherein the computer unit is programmed to store or to send in reaction to a triggering signal, additional signals, which contain the received signals of the operating parameter sensor or the receiving sensor and weather conditions or information regarding the individual operator of the machine or the time of the triggering signal.

7. The arrangement according to claim 1, wherein the crop sensor is set up to record the throughput, an ingredients content, or the color of the crop.

8. The arrangement according to claim 1, wherein the operating parameter sensor is set up, which records the driving performance, a force of a driven element of the machine, or the element moved over the field.

9. The arrangement according to claim 1, wherein in that the computer unit is programmed to generate different triggering signals for different conditions of the received signals of the operating parameter sensor and the crop sensor and to store different image signals, dependent on the individual triggering signal and additional signals or to send them to the site at a distance.

10. The arrangement according to claim 1, wherein the computer device is connected with an input device, with which the conditions of the signals of the operating parameter sensor or the crop sensor, which lead to the generation of the triggering signal, can be inputted and the image signals, stored or sent with the generation of a triggering signal.

11. The arrangement according to claim 1, wherein the computer device can be operated to note the image signals in a yield card.

12. The arrangement according to claim 1, wherein an evaluation device for the automatic evaluation of the stored image signals.

13. The arrangement according to claim 1, wherein the computer device can be operated to continuously store the image signals in a temporary storage unit and only upon the generation of a triggering signal, to transmit the image signals extending over a predefined time period, before and after the triggering signal, to a permanent storage unit.

14. The arrangement according to claim 1 wherein the arrangement is in or on an agricultural machine.

15. A method for the automatic documentation of situations during field work, the method comprising the following:
recording an operating parameter of an agricultural machine during field work and a characteristic of the crop that is gathered or processed by the agricultural machine during field work; and
generating a triggering signal with the occurrence of a predetermined condition of the operating parameter and/or the characteristic of the crop; wherein, as a reaction to a triggering signal, image signals of the agricultural machine or its surroundings are stored in a geo-referenced manner and are sent to a distant site over a transmission path.
